(19) United States
(12) Patent Application Publication
(10) Pub. No.: US 2026/0310871 A1
(43) Pub. Date: Oct. 8, 2026

(54) OPTIMIZED INTER-INTEGRATED CIRCUIT COMMUNICATION OUTPUT DRIVER

(71) Applicant: STMicroelectronics International N.V., Geneva (CH)

(72) Inventors: Francois TAILLIET, Fuveau (FR); Sylvain PASSEMARD, Cadenet (FR)

(21) Appl. No.: 19/172,189

(22) Filed: Apr. 7, 2025

(51) Int. Cl. G06F 30/38; G06F 119/12

(52) U.S. Cl. CPC G06F 30/38; G06F 2119/12

(57) ABSTRACT

An example I2C output driver, an electronic system comprising an I2C output driver, and a method for generating an I2C output signal based on a logic output signal are provided. The I2C output driver includes an output control transistor, gate pre-charge circuitry, and gate drive circuitry. The output control transistor includes a drain terminal electrically connected to an I2C output; a gate terminal receiving a gate output control signal; and a grounded source terminal. The gate pre-charge circuitry generates a pre-charge signal at a logical low state of the logic output signal. The gate output control signal composed of the pre-charge signal and the output transistor gate control signal. Wherein, a fall time of an I2C output signal transmitted on the I2C output line is controlled based on the pre-charge signal, the output transistor gate control signal, and a gate-drain capacitance.

### TECHNOLOGICAL FIELD

Embodiments of the present disclosure relate generally to an inter-integrated circuit (I2C) communication output driver, and more particularly, to an improved circuit design for an I2C communication output driver.

### BACKGROUND

The inter-integrated circuit (I2C) communication protocol enables simple communication between multiple devices using two signals: a clock signal and a data signal. The I2C protocol is a serial protocol that is widely used by microcontrollers, memories, computer monitors, sensors, and many other interconnected devices. The I2C communication protocol is a half-duplex communication system in which only a single controller or target device is configured to utilize the data signal to transmit data to or from target devices on the I2C data bus. Thus, the I2C protocol utilizes the clock signal to synchronize communication between devices. Electronic devices utilize an I2C output driver to send I2C communication signals on the I2C data bus. The I2C protocol is widely used because of its simplicity and power efficiency.

Applicant has identified many technical challenges and difficulties associated with circuitry of an I2C output driver. Through applied effort, ingenuity, and innovation, Applicant has solved problems related to the circuitry of an I2C output driver by developing solutions embodied in the present disclosure, which are described in detail below.

### BRIEF SUMMARY

Various embodiments are directed to an example I2C output driver, an electronic system comprising an I2C output driver, and a method for generating an I2C output signal based on a logic output signal.

An example I2C output driver configured to receive a logic output signal is provided. The example I2C output driver comprising an output control transistor, gate pre-charge circuitry, and gate drive circuitry. The output control transistor, comprising a drain terminal electrically connected to an I2C output line; a gate terminal configured to receive a gate output control signal; a source terminal electrically connected to an electrical ground; and a gate-drain capacitance based on a geometry of the drain terminal and the gate terminal. The gate pre-charge circuitry configured to generate a pre-charge signal at a logical low state of the logic output signal. The gate drive circuitry configured to generate an output transistor gate control signal based on the logic output signal. The gate output control signal comprises the pre-charge signal and the output transistor gate control signal. A fall time of an I2C output signal transmitted on the I2C output line is controlled based on the pre-charge signal, the output transistor gate control signal, and the gate-drain capacitance.

In some embodiments, the I2C output signal is one of a serial data line and a serial clock line.

In some embodiments, the fall time of the I2C output signal is dependent on the gate-drain capacitance, the pre-charge signal, and the output transistor gate control signal.

In some embodiments, the fall time of the I2C output signal is greater than 5.8 nanoseconds and less than 120 nanoseconds.

In some embodiments, a gate-drain overlap of the gate terminal of the output control transistor and the drain terminal of the output control transistor is greater than a gate-source overlap of the gate terminal of the output control transistor and the source terminal of the output control transistor.

In some embodiments, the output control transistor comprises a high voltage transistor comprising a voltage rating of at least 5.5 Volts.

In some embodiments, the gate drive circuitry comprises a first transistor, a current source, and a second transistor electrically connected in series, wherein the first transistor and the second transistor comprise opposite channel types, and wherein the first transistor and the second transistor are configured to receive the logic output signal.

In some embodiments, the gate pre-charge circuitry comprises a third transistor, a plurality of diode connected transistors, and a fourth transistor electrically connected in series, wherein a pre-charge control signal is generated between the third transistor and the plurality of diode connected transistors.

In some embodiments, the gate pre-charge circuitry further comprises a fifth transistor configured to generate the pre-charge signal based on the pre-charge control signal in an instance in which the logic output signal transitions from a logic high to a logic low.

In some embodiments, the I2C output driver further comprises latch-up protection circuitry, wherein the latch-up protection circuitry reduces a voltage of the gate output control signal in an instance in which the gate output control signal approaches a threshold voltage.

In some embodiments, the latch-up protection circuitry comprises a sixth transistor electrically connected in series with the fourth transistor between the gate terminal of the output control transistor and the electrical ground, wherein the sixth transistor and the fourth transistor comprise opposite channel types.

An example electronic system is further provided. In some embodiments, the example electronic system comprises data generator circuitry and an I2C output driver. The data generator circuitry configured to generate one or more data output signals. The I2C output driver comprising an output control transistor, gate pre-charge circuitry, and gate drive circuitry. The output control transistor, comprising a drain terminal, a gate terminal, a source terminal, and a gate-drain capacitance. The drain terminal electrically connected to an I2C data line. The gate terminal configured to receive a gate output control signal. The source terminal electrically connected to an electrical ground. The gate-drain capacitance based on a geometry of the drain terminal and the gate terminal. The gate pre-charge circuitry configured to generate a pre-charge signal at a logical low state of the logic output signal. The gate drive circuitry configured to generate an output transistor gate control signal based on the data output signal. Wherein the gate output control signal comprises the pre-charge signal and the output transistor gate control signal; and wherein a fall time of an I2C data signal transmitted on the I2C data line is controlled based on the pre-charge signal, the output transistor gate control signal, and the gate-drain capacitance.

In some embodiments, the fall time of the I2C data signal is dependent on the gate-drain capacitance, the pre-charge signal, and the output transistor gate control signal.

In some embodiments, the fall time of the I2C data signal is greater than 5.8 nanoseconds and less than 120 nanoseconds.

In some embodiments, a gate-drain overlap of the gate terminal of the output control transistor and the drain terminal of the output control transistor is greater than a gate-source overlap of the gate terminal of the output control transistor and the source terminal of the output control transistor.

In some embodiments, the gate drive circuitry comprises a first transistor, a current source, and a second transistor electrically connected in series, wherein the first transistor and the second transistor comprise opposite channel types, and wherein the first transistor and the second transistor are configured to receive the logic output signal.

In some embodiments, the gate pre-charge circuitry comprises a third transistor, a plurality of diode connected transistors, and a fourth transistor electrically connected in series, wherein a pre-charge control signal is generated between the third transistor and the plurality of diode connected transistors; and a fifth transistor configured to generate the pre-charge signal based on the pre-charge control signal in an instance in which the logic output signal transitions from a logic high to a logic low.

In some embodiments, the I2C output driver further comprises latch-up protection circuitry, wherein the latch-up protection circuitry reduces a voltage of the gate output control signal in an instance in which the gate output control signal approaches a threshold voltage.

In some embodiments, the latch-up protection circuitry comprises a sixth transistor electrically connected in series with the fourth transistor between the gate terminal of the output control transistor and the electrical ground, and wherein the sixth transistor and the fourth transistor comprise opposite channel types.

A method for generating an I2C output signal based on a logic output signal is further provided. In some embodiments, the method comprising: receiving, at gate drive circuitry of an I2C output driver, the logic output signal; generating, at the gate drive circuitry, an output transistor gate control signal based on the logic output signal; receiving, at gate pre-charge circuitry of the I2C output driver, the logic output signal; generating, at the gate pre-charge circuitry, a pre-charge signal at a logical low state of the logic output signal; receiving, at a gate terminal of the output control transistor of the I2C output driver, a gate output control signal, wherein the gate output control signal comprises the pre-charge signal and the output transistor gate control signal, the output control transistor comprising: a drain terminal electrically connected to an I2C output line; the gate terminal; a source terminal electrically connected to an electrical ground; and a gate-drain capacitance based on a geometry of the drain terminal and the gate terminal. The method further comprising generating, on the I2C output line, the I2C output signal, wherein a fall time of the I2C output signal is controlled based on the pre-charge signal, the output transistor gate control signal, and the gate-drain capacitance.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an I2C output driver in accordance with an example embodiment of the present disclosure.

FIG. 2 illustrates an example circuit diagram of an I2C output driver comprising a gate pre-charge circuitry block in accordance with an example embodiment of the present disclosure.

FIG. 3 depicts a cross-section of an example modified logic transistor in accordance with an example embodiment of the present disclosure.

FIG. 4 depicts a cross-section of an example high voltage transistor in accordance with an example embodiment of the present disclosure.

FIGS. 5A-5C depict an example schematic diagram of an I2C output driver, illustrating the various circuitries in accordance with an example embodiment of the present disclosure.

FIGS. 6-9 depict example timing diagrams associated with an I2C output driver in accordance with an example embodiment of the present disclosure.

FIG. 10 depicts a block diagram of an example electronic system comprising an I2C output driver in accordance with an example embodiment of the present disclosure.

FIG. 11 depicts an example flow chart of a process for generating an I2C output signal based on a logic output signal in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

In various embodiments, digital signals may be described in relation to the present embodiments. In general, digital signals may occupy one of two states. Throughout the description, these two states may be described as a logical high state or a logical low state. A digital signal is at a logical high state when an electrical characteristic of the digital signal is above a logical threshold. For example, a voltage of the digital signal exceeds a logical threshold voltage. A digital signal is at a logical low state when an electrical characteristic of the digital signal is below a logical threshold. For example, a voltage of the digital signal is below a logical threshold voltage. The logical states of a digital signal may also be indicated by 0 (e.g., logical low state) and 1 (e.g., logical high state) as used interchangeably throughout.

When referencing a digital signal, the term “asserted” refers to the logical state of the digital signal when the digital signal is active. An active high digital signal is in an asserted state in an instance in which the digital signal is in a logical high state, and in a de-asserted state in an instance in which the digital signal is in a logical low state. An active low digital signal is in an asserted state in an instance in which the digital signal is in a logical low state, and in a de-asserted state in an instance in which the digital signal is in a logical high state.

Digital signals may transition from one logical state to another. A transition from a logical low state to a logical high state may be referred to as a rising edge of the digital signal. A transition from a logical high state to a logical low state may be referred to as a falling edge of the digital signal.

### OVERVIEW

Various example embodiments address technical problems associated with an I2C output driver. As understood by those of skill in the field to which the present disclosure pertains, there are numerous example scenarios in which a system may benefit from improvements in the design of an I2C output driver.

For example, the inter-integrated circuit (I2C) communication protocol enables simple communication between multiple devices using two signals: a clock signal and a data signal. The I2C protocol is a serial protocol that is widely used by microcontrollers, memories, computer monitors, sensors, and many other interconnected devices. The I2C communication protocol is a half-duplex communication system in which only a single controller or target device is configured to utilize the data signal to transmit data to or from target devices on the I2C data bus. Thus, the I2C protocol utilizes the clock signal to synchronize communication between devices. Electronic devices utilize an I2C output driver to send I2C communication signals on the I2C data bus. The I2C protocol is widely used because of its simplicity and power efficiency.

In general, an I2C output driver utilizes transitions of the data signal to indicate data transitions (e.g., start and stop of transfer), in addition to the transmission of data. An I2C line (e.g., I2C clock line, I2C data line) is held at a logical high state by a pull-up resistor or other circuitry associated with the I2C bus. As such, the I2C output driver may pull the I2C line down (e.g., toward electrical ground) and release the I2C line (e.g., allowing it to return to a logical high state) in order to transmit data. Timing the transition of the I2C output signal transmitted on the I2C line may require precise timing. As such, the I2C protocol specification establishes various timing characteristics of the I2C output signals (e.g., I2C clock signal, I2C data signal). An I2C output driver is required to meet the timing characteristics of the I2C output signals to ensure accurate communication. One such timing characteristic is a signal fall time. A signal fall time is the duration of time for an I2C output signal to transition from a logical high state to a logical low state.

The I2C protocol specification may establish a minimum and/or maximum signal fall time. For example, in a standard mode, the specification may establish a maximum signal fall time for both the I2C data signal and the I2C clock signal of 300 nanoseconds. In a fast mode, the specification may establish a minimum signal fall time based on the positive supply voltage of the I2C output driver. For example, a minimum signal fall time in nanoseconds may be twenty times the positive supply voltage divided by 5.5 (e.g., with a positive supply voltage of 1.6 volts, a minimum signal fall time of 5.82 nanoseconds). The maximum signal fall time for both the I2C data signal and the I2C clock signal in fast mode may be established at 300 nanoseconds. In a fast mode plus, the specification may similarly establish a minimum signal fall time based on the positive supply voltage of the I2C output driver, for example, twenty times the positive supply voltage divided by 5.5. The maximum signal fall time for both the I2C data signal and the I2C clock signal in fast mode may be established at 120 nanoseconds. Thus, the I2C output driver must regulate the signal fall time of an I2C output signal to comply with the I2C communication protocol.

In some examples, a feedback capacitor is disposed in conjunction with an output control transistor to control the falling slope of the I2C output signal. For example, an external feedback capacitor may be electrically connected between the I2C line and the gate terminal of the output control transistor. A resulting current, proportional to the slope of the I2C output signal is injected into either a resistor connected to the positive supply voltage, or into a current source connected to the positive supply voltage, causing a drop of the gate voltage at the output control transistor. The closed-loop feedback controls the I2C output signal falling slope making it independent of the I2C line. Utilizing a resistor enables transition times independent of the positive supply voltage (e.g., steeper slope at higher positive supply voltage) while current sources enable positive supply voltage independent slopes of the I2C output signal (e.g., a shorter transition at lower positive supply voltage). However, utilizing an additional, external capacitor between the I2C line and the gate terminal of the output control transistor has a number of drawbacks. For example, the external capacitor requires additional area, the external capacitor further consumes additional power, in addition, the external capacitor increases the capacitance at the I2C output line pin. As such, there is a need for I2C output driver circuitry to reduce the overall size of the I2C output driver, reduce the power consumption of the I2C output driver, and reduce the capacitance at the I2C output line pin.

The various example embodiments described herein utilize various techniques to reduce the size, power consumption, and output line pin capacitance of an I2C output driver. For example, in some embodiments, the external feedback capacitor electrically connected between the I2C line and the gate terminal of the output control transistor is removed. Removing the external feedback capacitor reduces the overall area occupied and the power consumption of the I2C output driver. In addition, the capacitance of the I2C output line pin is reduced. Instead, parasitic capacitances within the output control transistor, such as a gate-drain capacitance, are utilized to control the fall time of the I2C output signal. The gate-drain capacitance is an internal capacitance (e.g., Miller capacitance) between a doped drain region of the output control transistor and the gate of the output control transistor.

In some embodiments, the internal gate-drain capacitance of the output control transistor may be less than an external capacitor. For example, the internal gate-drain capacitance may be at or near 0.05 picofarads, while a traditional feedback capacitor has a capacitance at or near 1 picofarad. To compensate for the reduced capacitance at the output control transistor, the current generated by the current source providing an output transistor gate control signal to the gate of the output control transistor must be reduced to maintain the same change in voltage of the I2C output signal. However, a reduction in current supplied to the gate of the output control transistor may increase the time required to bring the gate voltage of the output control transistor above the threshold voltage. In other words, the output control transistor turn on delay is increased. An increased turn on delay may be in violation of the I2C communication protocol standard.

To compensate for a lower current source at the gate of the output control transistor, and extended turn on delay, gate pre-charge circuitry may be utilized. The gate pre-charge circuitry may increase the current at the gate of the output control transistor in an instance in which the logic output signal provided to the I2C driver transitions from a logic high state to a logic low state. Thus, the output control transistor may turn on faster, connecting the I2C line to electrical ground.

In addition, in some embodiments, the geometry of the output control transistor may be modified to increase the gate-drain capacitance within the output control transistor. For example, the overlap of the gate of the output control transistor with the doped drain region of the output control transistor (e.g., gate-drain overlap) may be increased, thus increasing the gate-drain capacitance. In some embodiments, a high voltage transistor may be utilized for which the gate-drain overlap results in a higher gate-drain capacitance than a standard transistor. The increase in gate-drain capacitance may enable increases in the current of the output transistor gate control signal provided to the gate of the output control transistor.

As a result of the herein described example embodiments, the area occupied by an I2C output driver may be greatly reduced. In addition, removing the external feedback capacitor may reduce the power consumed by an I2C output driver. Further, the removal of the feedback capacitor may reduce the capacitance at the I2C output line pin.

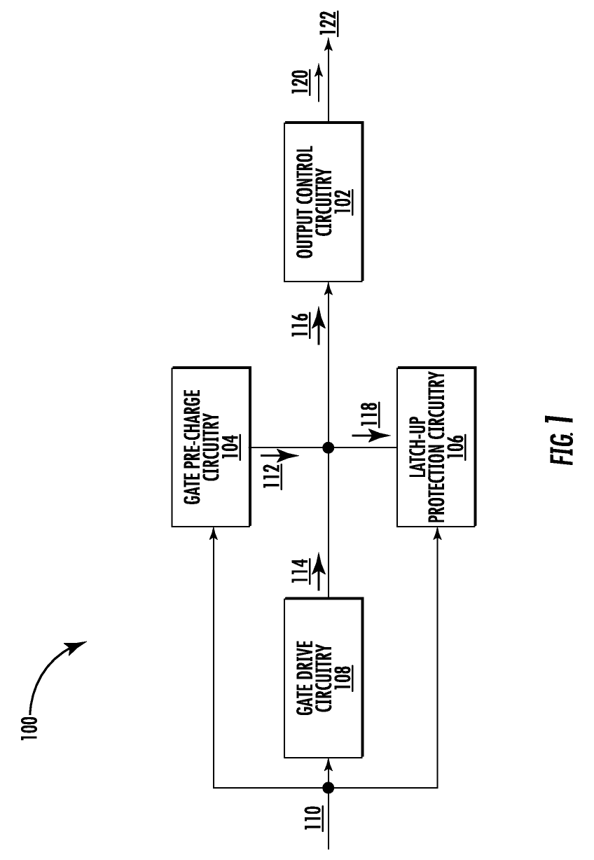

Referring now to FIG. 1, a block diagram of an example I2C output driver is provided. As depicted in FIG. 1, the example I2C output driver is configured to receive a logic output signal 110. The logic output signal 110 is transmitted to gate drive circuitry 108, gate pre-charge circuitry 104 and latch-up protection circuitry 106. The gate drive circuitry 108 is configured to generate an output transistor gate control signal 114 based at least in part on the logic output signal 110. The gate pre-charge circuitry 104 is configured to generate a pre-charge signal 112 based at least in part on the logic output signal 110. In addition, the latch-up protection circuitry 106 is configured to receive a latch-up control signal. As further depicted in FIG. 1, the gate output control signal 116 results from the combination of the pre-charge signal 112, the output transistor gate control signal 114, and the latch-up control signal 118. The gate output control signal 116 is transmitted to the output control circuitry 102 to generate the I2C output signal 120 on an I2C line 122.

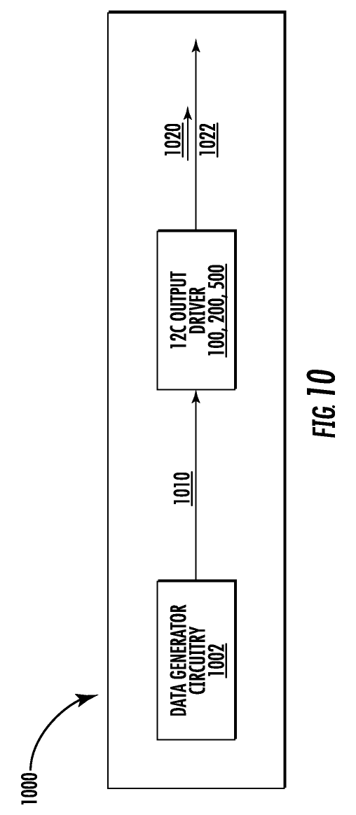

As depicted in FIG. 1, the I2C output driver 100 is configured to receive a logic output signal 110. A logic output signal 110 comprises any signal type configured to represent data using discrete values (e.g., logic high state, logic low state). A logic output signal 110 may be generated by an electronic system (e.g., electronic system 1000 as described in relation to FIG. 10) for transmission on an I2C output driver 100. For example, an electronic system may represent various data utilizing discrete values and provide the discrete values via a logic output signal 110 to the I2C output driver 100. The I2C output driver 100 may then transmit the logic output signal 110 in accordance with the I2C communication protocol.

As further depicted in FIG. 1, the I2C output driver 100 is configured to generate the I2C output signal 120 on the I2C line 120. In general, the I2C output signal 120 follows the logic output signal 110 after a delay.

As further depicted in FIG. 1, the I2C output driver 100 includes gate drive circuitry 108. Gate drive circuitry 108 comprises any circuitry including hardware and/or software configured to receive a logic output signal 110 and generate an output transistor gate control signal 114 based on the logic output signal 110 such that the I2C output signal 120 corresponds to the logic output signal 110. For example, in some embodiments, the gate drive circuitry 108 may comprise an inverter such that the logic state of the output transistor gate control signal 114 is opposite of the logic output signal 110. In such an embodiment, the output transistor gate control signal 114 may control an output control transistor, for example that pulls the I2C output signal 120 to electrical ground in an instance in which the output control transistor is enabled.

The output transistor gate control signal 114 may operate as an analog signal in control of the output control transistor of the output control circuitry 102. For example, the output transistor gate control signal 114 may be configured to either turn off the output control transistor, or turn on the output control transistor. However, when the output transistor gate control signal 114 turns on the output control transistor (e.g., the voltage level is above the threshold of the output control transistor), the voltage level of the output transistor gate control signal is not fixed. For example, the voltage level varies according to fall time control based on the tradeoff between the current provided by the gate pre-charge circuitry 104 (e.g., gate pre-charge signal 112), and feedback capacitance of the output control transistor.

In some embodiments, the output transistor gate control signal 114 may comprise a current, voltage, or other characteristics in conformity with the operation standards of the output control circuitry 102. For example, the gate drive circuitry 108 may include a current source that generates a current in accordance with the ratings of the output control circuitry 102.

As further depicted in FIG. 1, the I2C output driver 100 includes output control circuitry 102. The output control circuitry 102 comprises any circuitry including hardware and/or software configured to control the I2C output signal 120 on the I2C line 122 based on the gate output control signal 116. In general, the I2C line 122 is an open drain line. As such, by default the I2C output signal 120 on the I2C line 122 is pulled high by the circuitry associated with the I2C bus. The output control circuitry 102 may pull the output signal 120 to a logical low state by enabling circuitry to electrically connect the I2C line 122 to an electrical ground.

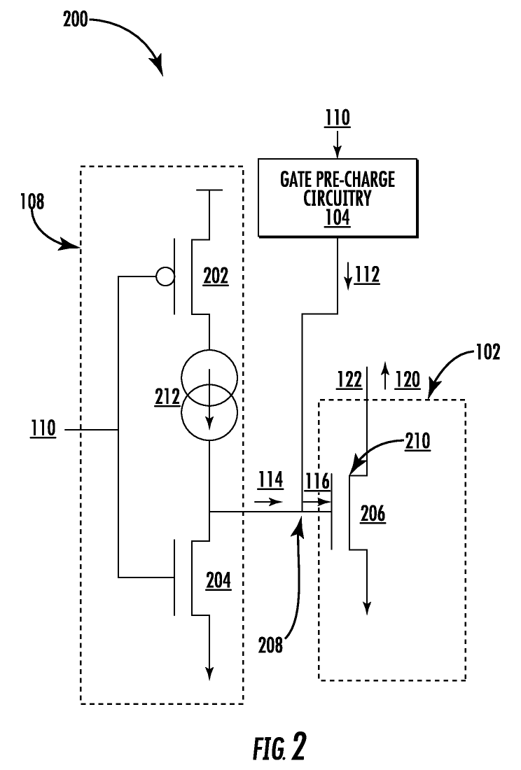

Thus, the output control circuitry 102 may be configured in accordance with the I2C communication protocol to electrically connect the I2C line 122 to an electrical ground to transmit a logical low state and to disconnect the I2C line 122 from electrical ground to transmit a logical high state. As such, in some embodiments, the output control circuitry may comprise an output control transistor (e.g., output control transistor 206 as further described in relation to FIG. 2). In such an embodiment, in an instance in which the output control transistor is enabled, the I2C line 122 is electrically connected to electrical ground. Further, in an instance in which the output control transistor is disabled, the I2C line 122 is disconnected from electrical ground and pulled to a logical high state by the I2C bus circuitry. In some embodiments, the gate output control signal 116 may control the state of the output control transistor. When low, the output control signal 116 applied to the gate of the output control transistor is typically at the ground voltage. However, when high, the output control signal 116 is not at a fixed determined level. When high, the output control signal 116 is typically above the threshold of the output control transistor and up to the power supply voltage, in order to turn on the output control transistor. However, unlike common logic signals, the high level of the output control signal is not fixed. Indeed, the voltage of the output control signal 116 determines the fall time of the I2C output signal 120. For example, the higher the voltage of the output control signal 116, the faster the fall time of the I2C output signal 120. The output control signal may comprise the output transistor gate control signal 114 and the pre-charge signal 112. In an instance in which the latch-up protection circuitry 106 is enabled, the latch-up control signal 118 may reduce the gate output control signal 116.

As further depicted in FIG. 1, the I2C output driver 100 includes gate pre-charge circuitry 104. The gate pre-charge circuitry 104 comprises any circuitry including hardware and/or software configured to generate a pre-charge signal 112 based on a transition of the logic output signal 110 from a logical high state to a logical low state. As described herein, the output control circuitry 102 may enable a transistor (e.g., output control transistor) to electrically connect the I2C line 122 to an electrical ground based on the gate output control signal 116. In some embodiments, the output transistor gate control signal 114 generated by the gate drive circuitry 108 may comprise a relatively low current (e.g., 5 microamps). Receiving a relatively low current at the output control circuitry 102 (in particular at the gate of the output control transistor), may increase the time required to bring the gate voltage of the output control transistor above the threshold voltage of the transistor. Thus, the output control transistor turn on delay is increased. An increased turn on delay may be in violation of the I2C communication protocol standard.

As such, the gate pre-charge circuitry 104 may be configured to generate a pre-charge signal 112 in an instance in which the logic output signal 110 transitions from a logical high state to a logical low sate. The pre-charge signal 112 may increase the change in voltage at the gate terminal of the output control transistor, reducing the turn on delay of the output control circuitry 102.

As further depicted in FIG. 1, the I2C output driver 100 may include latch-up protection circuitry 106. Latch-up protection circuitry 106 comprises any circuitry including hardware and/or software configured to reduce the charge at the output control circuitry 102 in an instance in which the voltage of the gate output control signal 116 received at the output control circuitry 102 nears or exceeds a threshold voltage (e.g., the voltage rating of the output control transistor). In some embodiments, the latch-up protection circuitry 106 may enable an electrical connection between the input terminal of the output control circuitry 102 and the electrical ground. Enabling an electrical connection between the input terminal of the output control circuitry 102 and the electrical ground may cause a latch-up control signal 118 to flow from the output control circuitry 102 to the electrical ground, reducing the voltage at the output control circuitry 102.

Referring now to FIG. 2, an example I2C output driver 200 is provided. As depicted in FIG. 2, the example I2C output driver 200 includes gate drive circuitry 108 configured to receive a logic output signal 110 and generate an output transistor gate control signal 114. As further depicted in FIG. 2, the I2C output driver 200 comprises gate pre-charge circuitry 104 configured to receive the logic output signal 110 and generate a pre-charge signal 112. The output control circuitry 102 is configured to receive the gate output control signal 116, comprising the output transistor gate control signal 114 and the pre-charge signal 112, and generate a I2C output signal 120.

As depicted in FIG. 2, the gate drive circuitry 108 comprises a first p-channel metal-oxide-semiconductor (PMOS) 202, a current source 212, and a first n-channel metal-oxide semiconductor (NMOS) 204. The first PMOS 202, the current source 212, and the NMOS 204 are electrically connected in series in an inverter configuration. Thus, in an instance in which the logic output signal 110 is in a logical high state, the first PMOS 202 is disabled and the first NMOS is enabled, electrically connecting the net point 208 to electrical ground and pulling the output transistor gate control signal 114 to a logical low state. In such an instance, the output control transistor 206 is disabled and the I2C output signal 120 on the I2C line 122 is kept at a logical high state. In an instance in which the logic output signal 110 is in a logical low state, the first PMOS 202 is enabled and the first NMOS is disabled, electrically connecting the net point 208 to a supply voltage through current source 212 and generating an output transistor gate control signal 114 in a logical high state comprising a characteristic current based on the current source 212. In such an instance, the output control transistor 206 is enabled and the I2C line 122 is electrically connected to the electrical ground, pulling the I2C output signal 120 into a logical low state.

As further depicted in FIG. 2, the output control circuitry 102 comprises an output control transistor 206. The output control transistor 206 of FIG. 2 comprises a drain terminal electrically connected to the I2C line 122, a gate terminal electrically connected to the net point 208 and configured to receive the gate output control signal 116 comprising the output transistor gate control signal 114 and the pre-charge signal 112, and a source terminal electrically connected to electrical ground. As depicted in FIG. 2, the output control transistor 206 comprises an NMOS transistor, thus, in an instance in which a voltage of the gate output control signal 116 exceeds the threshold voltage of the output control transistor 206, the output control transistor 206 is enabled and the I2C line 122 is electrically connected to the electrical ground, pulling the logical state of the I2C output signal 120 to a logical low state.

As further illustrated in FIG. 2, the output control transistor 206 comprises a gate-drain capacitance 210. The gate-drain capacitance 210 comprises the parasitic capacitance between the gate and the drain regions of a transistor. The parasitic capacitance between regions of a transistor may be referred to as the Miller capacitance. The gate-drain capacitance 210 arises due to the geometry of the gate and drain regions of a transistor. For example, the gate-drain capacitance 210 may correspond to the overlap of the gate and drain regions of a transistor. Such a parasitic capacitance may be formed by the oxide layer between the gate region and the drain region, acting as a dielectric between the two conductive regions.

As described herein, the I2C output driver 200 may utilize the gate-drain capacitance 210 of the output control transistor 206 to control the fall time of the I2C output signal 122 in an instance in which the output control transistor 206 is enabled. The fall time of the I2C output signal 122 relates to the time duration required for the voltage of the I2C output signal 122 to drop from above a logical high state threshold to below a logical low state threshold. For example, in some embodiments, the fall time of the I2C output signal 122 is the time to fall from seventy percent of the positive supply voltage on the I2C bus (Vdd) to 30 percent of the positive supply voltage on the I2C bus (Vdd). The current of the gate output control signal 116 may be selected based on the gate-drain capacitance 210 such that the fall time of the I2C output signal 122 is within the parameters specified by the I2C communication protocol specification. In some embodiments, the fall time of the I2C output signal 122 may be between 0 nanoseconds and 300 nanoseconds; more preferably between 5.8 nanoseconds and 300; most preferably between 5.8 nanoseconds and 120 nanoseconds. In some embodiments, the fall time may be dependent on the positive supply voltage of the I2C bus.

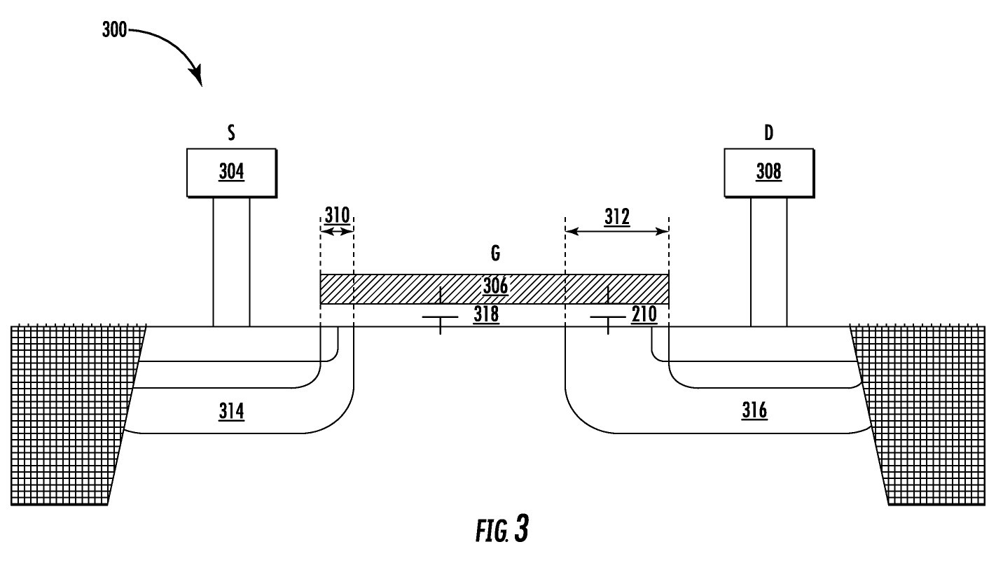

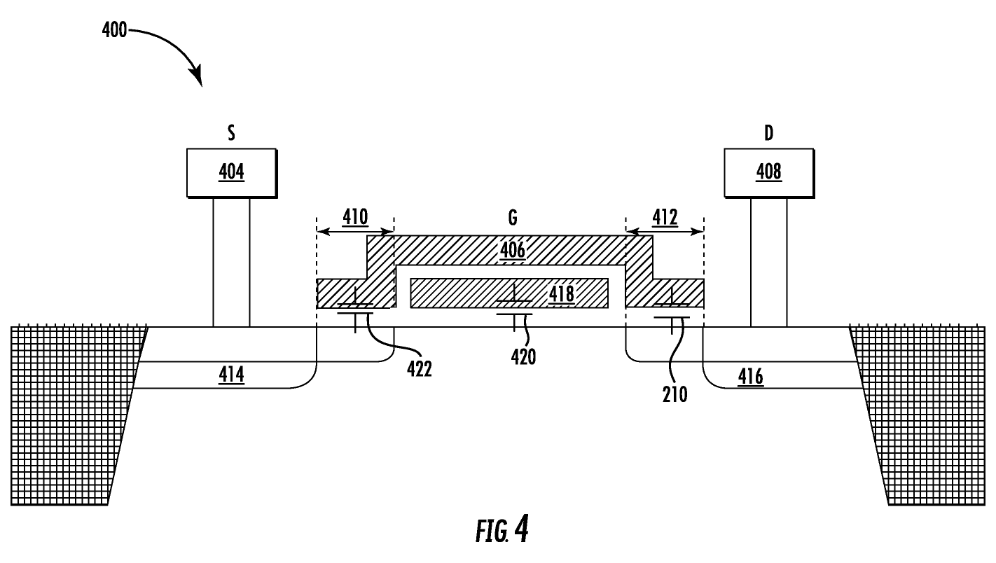

In some embodiments, the geometry of the output control transistor 206 may be modified to change the gate-drain capacitance 210 of the output control transistor 206. For example, the overlap of the gate region and drain region of the output control transistor 206 may be increased to increase the gate-drain capacitance 210 without adding additional capacitor components external to the output control transistor 206. An example of a modified transistor is described in relation to FIG. 3. In some embodiments, the output control transistor may comprise a high voltage transistor. A high voltage transistor may comprise a transistor configured with a voltage rating at or above 5.5 volts. An example high voltage transistor is further described in relation to FIG. 4.

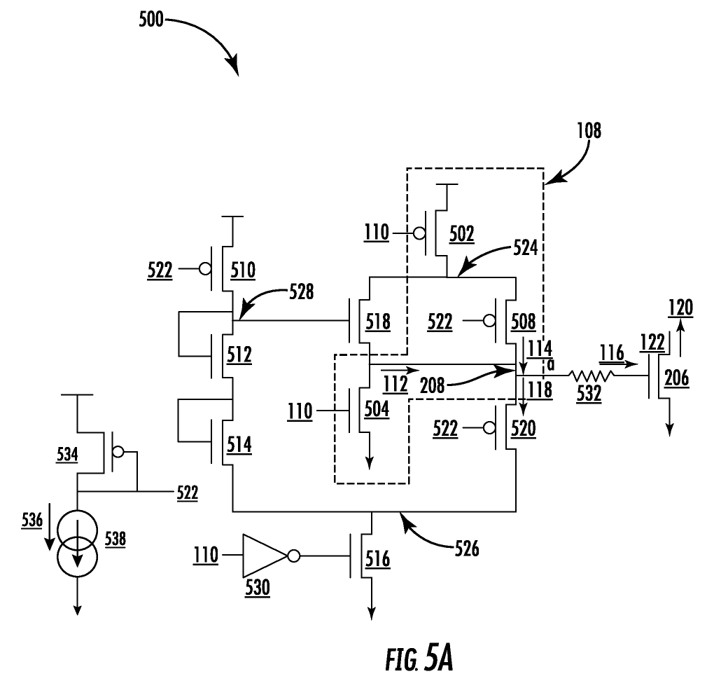

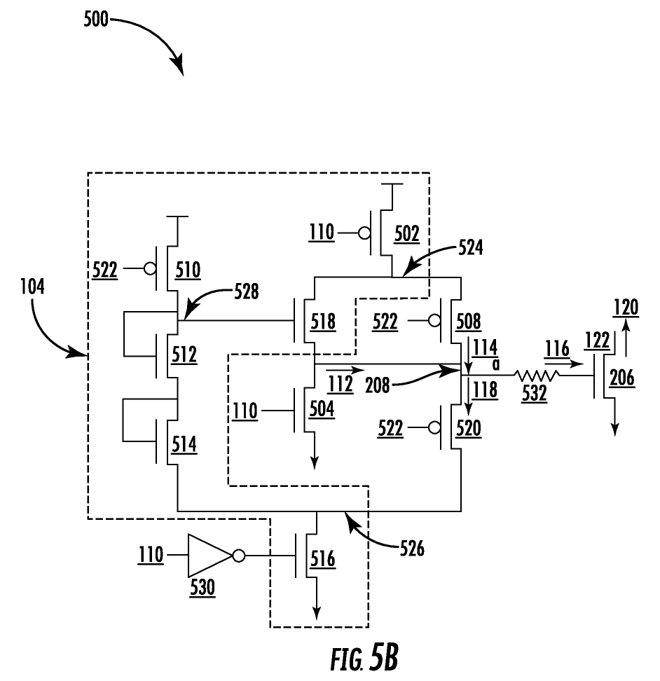

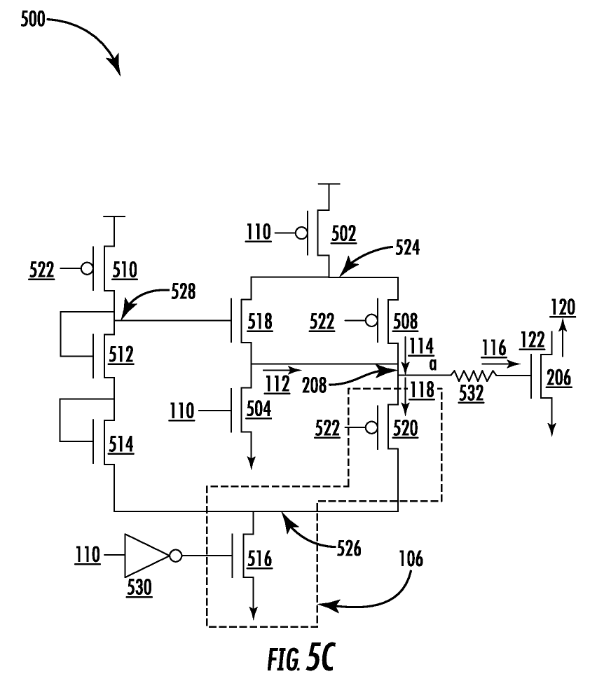

As further depicted in FIG. 2, the I2C output driver 200 may include gate pre-charge circuitry 104 configured to receive the logic output signal 110 and generate a pre-charge signal 112 based on the logical state of the logic output signal 110. For example, the gate pre-charge circuitry 104 may be configured to generate a current (e.g., pre-charge signal 112) in an instance in which the logic output signal 110 transitions from a logical high state to a logical low sate. The pre-charge signal 112 may increase the change in voltage at the gate terminal of the output control transistor 206. By increasing the voltage at the gate terminal of the output control transistor 206, reducing the turn on delay of the output control transistor 206 may be reduced. Example gate pre-charge circuitry 104 is further described in relation to FIG. 5B.

Referring now to FIG. 3, a cross-section of an example modified logic transistor 300 is provided. As depicted in FIG. 3, the example modified logic transistor 300 includes a source terminal 304 electrically connected to a doped source region 314, a gate 306, and a drain terminal 308 electrically connected to a doped drain region 316. As further depicted in FIG. 3, the gate 306 and source region 314 overlap by a gate-source overlap 310. In addition, the gate 306 and drain region 316 overlap by a gate-source overlap 310. As illustrated in FIG. 3, a first parasitic capacitance (e.g., gate-drain capacitance 210) is formed between the gate 306 and the drain region 316, and a second parasitic capacitance (e.g., gate-channel capacitance 318) is formed between the gate 306 and the substrate channel of the modified logic transistor 300.

As described herein, the capacitance value of a parasitic capacitances formed within a modified logic transistor 300 may vary depending on the geometry of the modified logic transistor 300. For example, a parasitic capacitance between the gate 306 and the source region 314 may vary based on the gate-source overlap 310. Similarly, the gate-drain capacitance 210 may vary based on the gate-drain overlap 312. In some embodiments, the gate-drain overlap 312 may be increased to increase the gate-drain capacitance 210. As further depicted in FIG. 3, in some embodiments, the gate-drain overlap 312 may be greater than the gate-source overlap 310. In such an instance, the gate-drain capacitance 210 may be greater than the parasitic capacitance between the gate 306 and the source region 314.

When utilized as an output control transistor, a gate-source capacitance (not pictured) is negligible compared to a gate-drain capacitance 210. Thus, the fall time of the I2C output signal 120 may depend on the ratio of the gate-drain capacitance 210 to the gate-channel capacitance 318.

Referring now to FIG. 4, a cross-section of an example high voltage transistor 400 is provided. As depicted in FIG. 4, the example high voltage transistor 400 includes a source terminal 404 electrically connected to a doped source region 414, a first gate 406, and a drain terminal 408 electrically connected to a doped gate region 416. In addition, the high voltage transistor 400 of FIG. 4 includes a second gate 418 disposed between the gate 406 and the substrate. As further depicted in FIG. 4, the gate 406 encloses at least a portion of the second gate 418 such that the gate 406 overlaps the source region 414 by a gate-source overlap 410 and the gate 406 overlaps the drain region 416 by a gate-drain overlap 412.

The transistor structure depicted in FIG. 4 may be derived from EEprom of flash type memory bitcells, wherein the transistor structure utilized two stacked polysilicon gates (polysilicon gate 406, polysilicon gate 418). In bitcells, the polysilicon gates are typically self-aligned (e.g., the gates edges are aligned, the two gates being etched at same time)). However, as depicted in FIG. 4, the high voltage transistor 400 may be designed such that the two gates 406, 418 are not self aligned. In such an embodiment, the two gates 406, 418 are short-circuited at one or both of their ends. Under gate 418 is a high voltage gate oxide. Between gate 418 and gate 406 is an isolating oxide. The isolating oxide is typically referred to as ONO (SIO2 / Si3N4 / SiO2 stack), wherein the "O" denotes oxide, and the "N" denotes Nitride.

As depicted in FIG. 4, a gate-source capacitance 422 is a result of the oxide capacitive region formed under the portions of the polysilicon gate 406 which do not overlap the second polysilicon gate 418 at the source terminal 404. Similarly, the gate-drain capacitance 210 is a result of the oxide capacitive region formed under the portions of the polysilicon gate 406 which do not overlap the second polysilicon gate 418 at the drain terminal 408. Because the gate-source overlap 410 and the gate-drain overlap 412 are defined by the drain extension of gate 406 beyond gate 418, in some embodiments, the overlap may be asymmetrical. In some embodiments, the high voltage transistor may be designed such that the gate-source capacitance 422 and the gate-drain capacitance is unequal. For example, the gate-drain capacitance 210 may be made to be significantly bigger than the gate-source capacitance 422.

Utilizing such principles, in some embodiments, the gate-drain capacitance 210 between the gate 406 of the high voltage transistor 400 and the drain region 416 may be increased compared to a standard logic transistor due, for example, to the increased gate-drain overlap 412. Increasing the gate-drain capacitance 210 at an output control transistor (e.g., output control transistor 206 as depicted in FIG. 2) may enable an increase in current provided to the gate 406 of the output control transistor to maintain the same fall time.

As further depicted in FIG. 4, parasitic capacitances are formed between the second gate 418 and the channel of the high voltage transistor 400 (e.g., oxide-channel capacitance 420).

When a high voltage capacitor 400 utilized as an output control transistor, the fall time of the I2C output signal 120 may depend on the ratio of the gate-drain capacitance 210 to the sum of the oxide-channel capacitance 420 and the gate-source capacitance 422.

Referring now to FIGS. 5A-5C, an example I2C output driver 500 is depicted. As depicted in FIGS. 5A-5C, the example I2C output driver 500 comprises a PMOS transistor 502 (e.g., first transistor) comprising a source terminal, a gate terminal, and a drain terminal. The source terminal is electrically connected to a positive voltage source. The gate terminal is electrically connected to a logic output signal 110. The drain terminal is electrically connected to the net point 524.

As depicted in FIGS. 5A-5C, the example I2C output driver 500 comprises a current source 508 comprising a PMOS transistor having a source terminal, a gate terminal, and a drain terminal. The source terminal electrically connected to the net point 524. The gate terminal electrically connected to a positive reference voltage 522. The drain terminal electrically connected to the net point 208.

As depicted in FIG. 5A, the positive reference voltage 522 is produced by PMOS transistor 534 which is a diode-connected transistor, meaning, the PMOS transistor 534 works in saturation mode. Through PMOS transistor 534 is injected a reference current 536 coming from a reference current source 538 which is typically a functional sub-block of the I2C circuit, and may be used for several analog purposes, not limited to the I2C output driver 500.

The positive reference voltage 522 is close to the power supply voltage minus the absolute value of the threshold of PMOS transistor 534. For example if the power supply voltage is 5 volts, and the threshold of PMOS transistor 534 is -0.8V, then the net positive reference voltage 522 will be at 5 volts minus 0.8 volts, or 4.2 volts. Any PMOS transistor which has its source at the potential of the power supply voltage and its gate at positive reference voltage 522 will mirror the current through PMOS transistor 534. Such is the case of PMOS transistor 510 and PMOS transistor 508.As further depicted in FIGS. 5A-5C, the example I2C output driver 500 comprises an NMOS transistor 504 (e.g., second transistor) comprising a source terminal, a gate terminal, and a drain terminal. The source terminal electrically connected to an electrical ground, the gate terminal electrically connected to the logic output signal 110. The drain terminal electrically connected to the net point 208.

As further depicted in FIGS. 5A-5C, the example I2C output driver 500 comprises an NMOS output control transistor 206. The NMOS output control transistor 206 comprising a source terminal, a gate terminal, and a drain terminal. The drain terminal electrically connected to the I2C line 122. The gate terminal electrically connected to a resistor 532, wherein the resistor 532 is electrically connected between the gate terminal of the NMOS output control transistor 206 and the net point 208. The source terminal electrically connected to the electrical ground.

As further depicted in FIGS. 5A-5C, the example I2C output driver 500 comprises a PMOS transistor 510 (e.g., third transistor) comprising a source terminal, a gate terminal, and a drain terminal. The source terminal electrically connected to the positive voltage source. The gate terminal electrically connected to the positive reference voltage 522. The drain terminal electrically connected to a net point 528.

As further depicted in FIGS. 5A-5C, the example I2C output driver 500 comprises a first diode connected NMOS transistor 512 and a second diode connected NMOS transistor 514 each comprising a source terminal, a gate terminal, and a drain terminal. The drain terminal of the first diode connected NMOS transistor 512 electrically connected to the net point 528 and the gate terminal of the first diode connected NMOS transistor 512. The source terminal of the first diode connected NMOS transistor 512 electrically connected to the drain terminal of the second diode connected NMOS transistor 514. The drain terminal of the second diode connected NMOS transistor 514 further electrically connected to the gate terminal of the second diode connected NMOS transistor 514. The source terminal of the second diode connected NMOS transistor 514 electrically connected to the net point 526.

As further depicted in FIGS. 5A-5C, the example I2C output driver 500 comprises an NMOS transistor 516 (e.g., fourth transistor) comprising a source terminal, a gate terminal, and a drain terminal. The drain terminal electrically connected to the net point 526. The gate terminal electrically connected to the output of an inverter 530, wherein the inverter 530 is configured to receive the logic output signal 110. The source terminal electrically connected to an electrical ground.

As further depicted in FIGS. 5A-5C, the example I2C output driver 500 comprises an NMOS transistor 518 (e.g., fifth transistor) comprising a source terminal, a gate terminal, and a drain terminal. The drain terminal electrically connected to the net point 524. The source terminal electrically connected to net point 528. The drain terminal electrically connected to the net point 208.

As further depicted in FIGS. 5A-5C, the example I2C output driver 500 comprises a PMOS transistor 520 (e.g., sixth transistor) comprising a source terminal, a gate terminal, and a drain terminal. The source terminal electrically connected to the net point 208. The gate terminal electrically connected to the positive reference voltage 522. The drain terminal electrically connected to the net point 526.

With reference to FIG. 5A, the electrical components of the I2C output driver 500 associated with example gate drive circuitry 108 are indicated. As depicted in FIG. 5A, the example gate drive circuitry 108 comprises the PMOS transistor 502, the current source 508, and the NMOS transistor 504 electrically connected in series between the positive voltage source and an electrical ground.

In an instance in which the logic output signal 110 transitions from a logical low state to a logical high state, the NMOS transistor 504 is enabled and the PMOS transistor 502 is disabled. Thus, the gate terminal of the output control transistor 206 is electrically connected to electrical ground through the NMOS transistor 504 and the output control transistor 206 is disabled. In such an instance, the I2C output signal 102 is pulled high by the I2C bus logic.

In an instance in which the logic output signal 110 transitions from a logical high state to a logical low state, the NMOS transistor 504 is disabled and the PMOS transistor 502 is enabled. Thus, the gate drive circuitry 108 generates an output transistor gate control signal 114 comprising a current based on the current source 508. The gate output control signal 116 based on the output transistor gate control signal 114 and the pre-charge signal 112 enable the output control transistor 206. With the output control transistor enabled, the I2C line 122 is electrically connected to ground. As described herein, the fall time of the I2C output signal 120 is dependent on the current of the gate output control signal 116 and the parasitic capacitances of the output control transistor 206.

With reference to FIG. 5B, the electrical components of the I2C output driver 500 associated with example gate pre-charge circuitry 104 are indicated. As depicted in FIG. 5B, the example gate pre-charge circuitry 104 comprises the PMOS transistor 502, NMOS transistor 518, the PMOS transistor 510, the diode connected NMOS transistor 512, the diode connected NMOS transistor 514, and the NMOS transistor 516.

The gate pre-charge circuitry 104 is configured to inject a pre-charge signal 112 into the gate output control signal 116 in an instance in which the logic output signal 110 transitions from a logical high state to a logical low state. Thus, in an instance in which the logic output signal 110 transitions from a logical high state to a logical low state, the NMOS transistor 516 and the PMOS transistor 502 are both enabled. As such, the series-connected NMOS transistor 512, NMOS transistor 514, and NMOS transistor 516 pull the voltage at the gate terminal of NMOS transistor 518 to the sum of the threshold voltage of NMOS transistor 512 plus the threshold voltage of NMOS transistor 514. In addition, the drain of NMOS transistor 518 is pulled to the value of the positive voltage source by the PMOS transistor 502. Further, with NMOS transistor 504 disabled, the source of NMOS transistor 518 raises to the threshold voltage of NMOS transistor 514 plus the threshold voltage of NMOS transistor 512 minus the threshold voltage of NMOS transistor 518. In some embodiments, the voltage of the source at the NMOS transistor 518 in an instance in which the logic output signal 110 transitions from a logical high state to a logical low state may be approximated by the threshold voltage of NMOS transistor 514 provided NMOS transistor 512 and NMOS transistor 518 have a similar threshold voltage.

In an instance in which NMOS transistor 514 and the output control transistor 206 have a similar threshold voltage, the pre-charge signal 112 generated by the gate pre-charge circuitry 104 quickly pulls the net point 208 to the threshold voltage of the output control transistor 206 because the NMOS transistor 518 provides a highly conductive path from the positive supply voltage through PMOS transistor 502 and NMOS transistor 518, in addition to the low current path provided by the PMOS transistor associated with the current source 508.

The gate pre-charge circuitry 104 enables the gate voltage at the output control transistor 206 to rise to the threshold voltage of the output control transistor 206 quickly, avoiding a long delay that would otherwise be present if the gate voltage was reliant only on the low current from the current source 508.

With reference to FIG. 5C, the electrical components of the I2C output driver 500 associated with example latch-up protection circuitry 106 are indicated. The latch-up protection circuitry 106 may prevent the voltage at the net point 208 (e.g., the gate of output control transistor 206) from exceeding a threshold voltage in an instance in which the logic output signal 110 is at a logical low state. Exceeding the threshold voltage may lead to a number of problems. For example, exceeding the threshold voltage may trigger bipolar effects in PMOS transistors. Similarly, dropping below electrical ground may trigger bipolar effects in NMOS transistors.

As depicted in FIG. 5C, the example latch-up protection circuitry 106 comprises the PMOS transistor 520 and the NMOS transistor 516. A potential risk of latch-up exists when logic output signal 110 is low and the I2C line 122 is driven low by output control transistor 206 which is on. In such an instance, I2C output signal 120 is low, and the voltage at net point 208 is high, for example, at the positive reference voltage. If the I2C bus forces a rising edge on the I2C line 122 creating a current conflict on the output control resistor 206, the capacitive drain-gate coupling in output control resistor 206 would tend to rise the potential of net point 208 above positive reference voltage. If the level of net point 208 exceeds the positive reference voltage by + 0.6V, the parasitic drain-bulk diode of PMOS transistor 508 may turn on and trigger latch-up (e.g., parasitic bipolar PNPN structure, also referred to as parasitic SCR, or parasitic thyristor, and inherent to usual CMOS processes). The PMOS transistor 520 prevents such a latch up by driving current to ground as soon as the potential at net point 208 exceeds the positive supply voltage. Resistor 532 limits the current injected into the source terminal of PMOS transistor 520, when the voltage at net point 208 exceeds the positive supply voltage, contributing to reduce the voltage at net point 208. In some embodiments, the threshold voltage at the net point 208 may comprise the positive supply voltage + 0.6 volts. As soon as the voltage at net point 208 voltage exceeds the positive supply voltage, PMOS transistor 520 starts to derive current to ground, and is dimensioned such that (based on its impedance) the max voltage at net point 208 never reaches the positive supply voltage + 0.6V.

In an instance in which the logic output signal 110 is at a logical low state, and the amplitude of the voltage at the net point 208 nears a threshold voltage, the PMOS transistor 520 is enabled and current flows from the net point 208, through the PMOS transistor 520, and through the NMOS transistor 516 to an electrical ground. Thus, the voltage at the net point 208 may remain below the positive voltage source. The threshold voltage may be defined based on the positive reference voltage 522. For example, as depicted in FIG. 5C, the gate at PMOS transistor 520 receives the positive reference voltage 522. When the drain terminal of the PMOS transistor 520 is at electrical ground (e.g., logic output signal 110 is low, NMOS transistor 516 is on, and net point 208 is high), the source terminal of the PMOS transistor 520 drives current to ground in an instance in which the voltage at the source terminal (e.g., net point 208) is higher than the gate terminal voltage (e.g., positive reference voltage 522) plus the absolute value of the threshold voltage of the PMOS transistor 520 (approximately the positive voltage source).

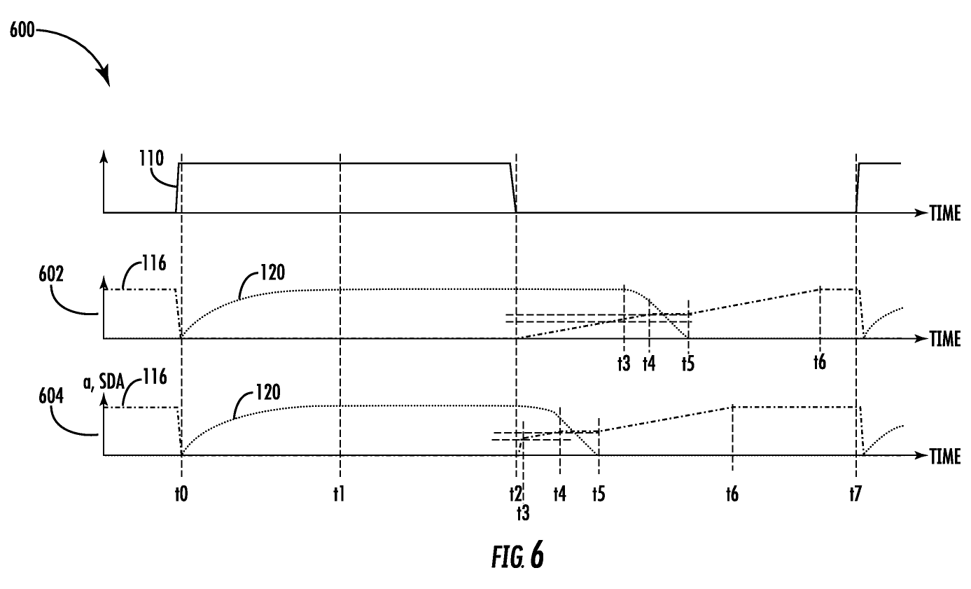

Referring now to FIG. 6, an example timing diagram 600 is provided. FIG. 6 depicts the I2C output signal 120 and the gate output control signal 116 in two example I2C output drivers. Signal diagram 602 depicts the I2C output signal 120 and the gate output control signal 116 for an I2C output driver with no gate pre-charge circuitry (e.g., gate pre-charge circuitry 104). Signal diagram 604 depicts the I2C output signal 120 and the gate output control signal 116 for an I2C output driver with gate pre-charge circuitry (e.g., I2C output driver 100, 200, 500).

As depicted in FIG. 6, at time t0, the logic output signal 110 transitions from a logical low state to a logical high state. In both signal diagram 602 and signal diagram 604, the gate output control signal 116 goes to 0 and the I2C output signal 120 begins to rise. Because the rise of the I2C output signal 120 is controlled by the I2C bus, the rise for both circuits is the same.

At time t2, the logic output signal 110 transitions from a logical high state to a logical low state. In response, the gate output control signal 116 begins to rise. As depicted in FIG. 6, the rise of the gate output control signal 116 is much faster on the signal diagram 604 based on an I2C output driver comprising gate pre-charge circuitry.

At time t3, the voltage at the gate terminal of the output control transistor reaches the threshold voltage of the output control transistor and the output control transistor starts to turn on As the output control transistor turns on, the voltage of the I2C output signal begins to decrease. The voltage at the gate terminal of the output control transistor continues to increase until the current from the current source 508 and the capacitive feedback current equalize at time t4. The I2C output signal falls linearly until it reaches a stable low level at time t5. The capacitive feedback current returns to 0. The voltage at the gate terminal of the output control transistor continues to increase until it reaches the threshold voltage at time t6.

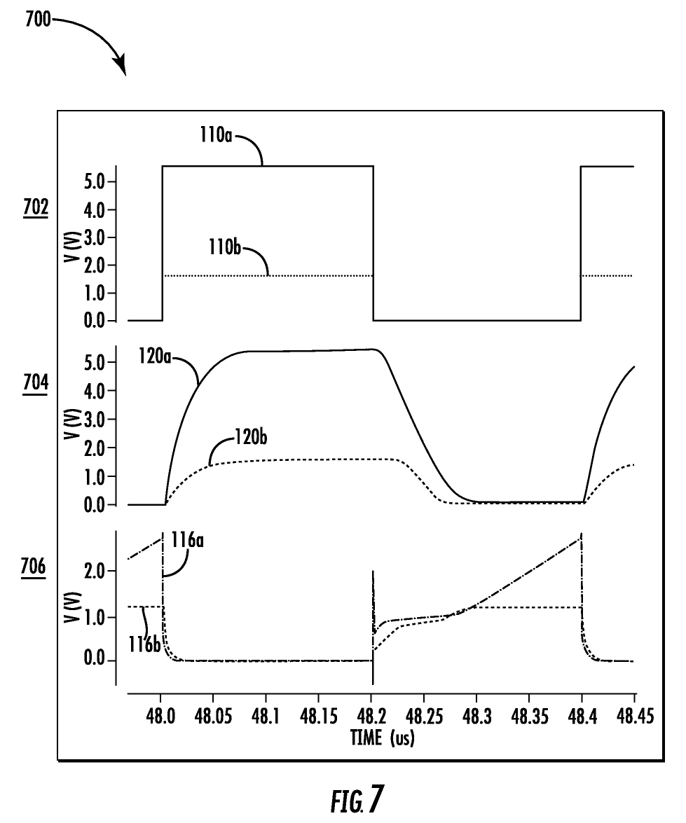

Referring now to FIG. 7, an example timing diagram 700 depicting rise and fall times of an I2C output signal (e.g., I2C output signal 120) generated using an I2C output driver (e.g., I2C output driver 100, 200, 500) is depicted.

Timing diagram 702 depicts a logic output signal 110a at a high voltage (e.g., 5.5 volts) and a logic output signal 110b at a low voltage (e.g., 1.6 volts).

Timing diagram 704 depicts the response of the I2C output signal 120a, 120b based on the changes to the logic output signal 110a, 110b. As depicted in timing diagram 704, the rise time of the I2C output signal 120a, 120b is controlled by the I2C bus. However, the fall time of the I2C output signal 120a, 120b is controlled by the output control transistor (e.g., output control transistor 206) of an I2C driver. As shown in timing diagram 704, the fall slope of the I2C output signal 120a, 120b is nearly constant.

Timing diagram 706 depicts the gate control signal 116a, 116b in response to the change in the logic output signal 110a, 110b. As depicted in timing diagram 706, both the gate control signals 116a, 116b initially rise quickly aided by the gate pre-charge circuitry 104.

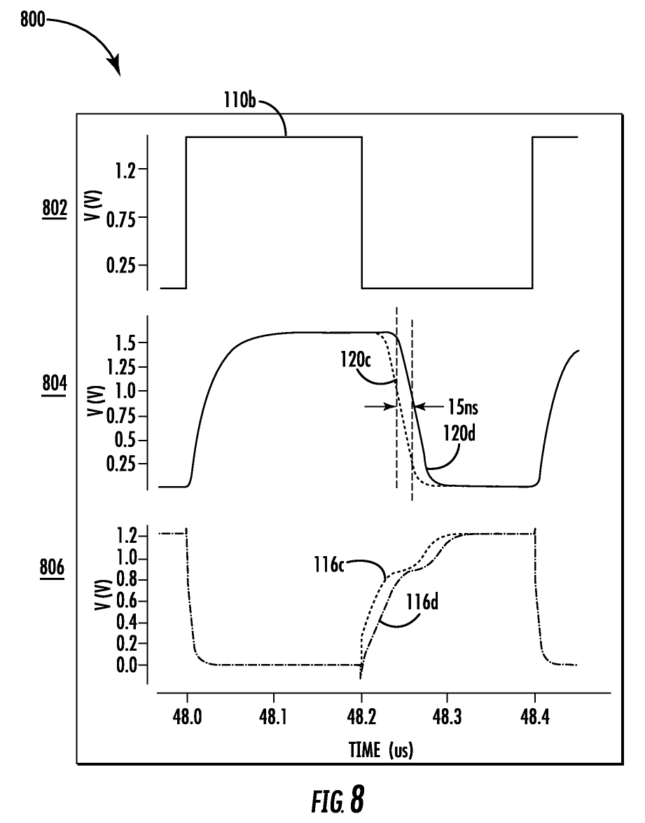

Referring now to FIG. 8, an example timing diagram 800 is provided. The example timing diagram 800 compares fall times in an I2C output driver (e.g., I2C output driver 100, 200, 500) having gate pre-charge circuitry 104 with fall times in an I2C output driver without gate pre-charge circuitry at a low voltage.

Timing diagram 802 depicts a logic output signal 110b at a low voltage (e.g., 1.6 volts).

Timing diagram 804 compares the fall time of the I2C output signal 120c, 120d in response to a change in the logic output signal 110b. I2C output signal 120c depicts the fall time of an I2C output driver with gate pre-charge circuitry 104, while I2C output signal 120d depicts the fall time of an I2C output driver without gate pre-charge circuitry 104. As depicted in timing diagram 804, due to the pre-charge signal (e.g., pre-charge signal 112) provided by the gate pre-charge circuitry (e.g., gate pre-charge circuitry 104), the fall of the I2C output signal 120c occurs about 15 nanoseconds earlier, than the fall of the I2C output signal 120d.

Timing diagram 806 depicts the corresponding gate output control signal 116c, 116d. Gate output control signal 116c depicts the gate output control signal of an I2C output driver with gate pre-charge circuitry 104, while gate output control signal 116d depicts the gate output control signal of an I2C output driver without gate pre-charge circuitry 104. As depicted in timing diagram 806, the gate output control signal 116c of the I2C output driver with gate pre-charge circuitry 104 rises faster than the gate output control signal 116d.

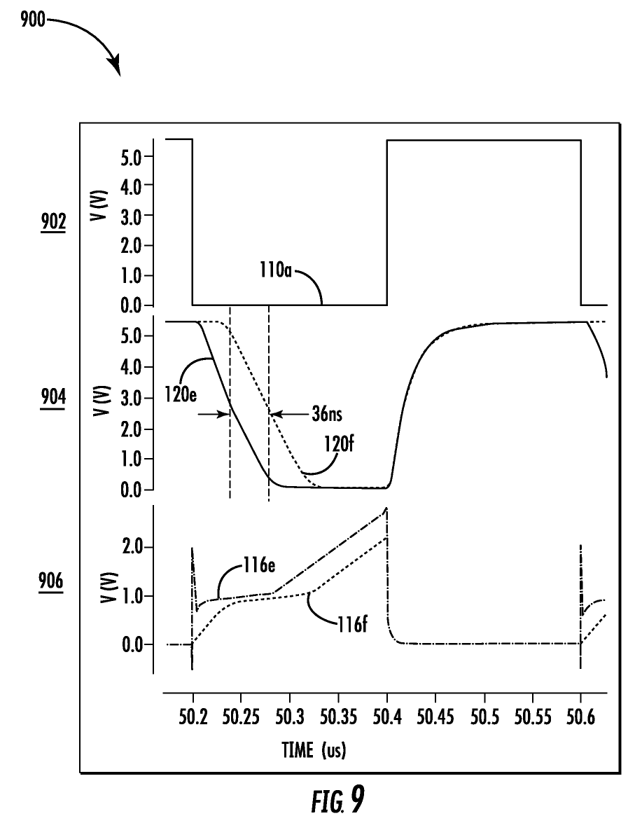

Referring now to FIG. 9, an example timing diagram 900 is provided. The example timing diagram 900 compares fall times in an I2C output driver (e.g., I2C output driver 100, 200, 500) having gate pre-charge circuitry 104 with fall times in an I2C output driver without gate pre-charge circuitry at a high voltage.

Timing diagram 902 depicts a logic output signal 110a at a high voltage (e.g., 5.5 volts).

Timing diagram 904 compares the fall time of the I2C output signal 120e, 120f in response to a change in the logic output signal 110a. I2C output signal 120e depicts the fall time of an I2C output driver with gate pre-charge circuitry 104, while I2C output signal 120f depicts the fall time of an I2C output driver without gate pre-charge circuitry 104. As depicted in timing diagram 904, due to the pre-charge signal (e.g., pre-charge signal 112) provided by the gate pre-charge circuitry (e.g., gate pre-charge circuitry 104), the fall of the I2C output signal 120e occurs about 36 nanoseconds earlier, than the fall of the I2C output signal 120f.

Timing diagram 906 depicts the corresponding gate output control signal 116e, 116f. Gate output control signal 116e depicts the gate output control signal of an I2C output driver with gate pre-charge circuitry 104, while gate output control signal 116f depicts the gate output control signal of an I2C output driver without gate pre-charge circuitry 104. As depicted in timing diagram 906, the gate output control signal 116e of the I2C output driver with gate pre-charge circuitry 104 rises faster than the gate output control signal 116f.

Referring now to FIG. 10 a block diagram example electronic system 1000 is provided. As depicted in FIG. 10, the electronic system 1000 includes data generator circuitry 1002 configured to generate data output signals 1010. Data generator circuitry 1002 comprises any circuitry including hardware and/or software configured to generate a digital signal encoding data in accordance with a communication protocol. For example, the data generator circuitry 1002 may be configured to encode data in a digital signal (e.g., data output signal 1010) in accordance with data transmission on an I2C data line 1022.

As further depicted in FIG. 10, the data generator circuitry 1002 is configured to provide the data output signal 1010 (e.g., logic output signal 110) to an I2C output driver configured in accordance with the present disclosure (e.g., I2C output driver 100, 200, 500). The I2C output driver is configured generate an I2C data signal 1020 (e.g., I2C output signal 120) on the I2C data line 1022 in accordance with the I2C communication protocol.

In some embodiments, the electronic system 1000 may comprise an I2C communication slave device.

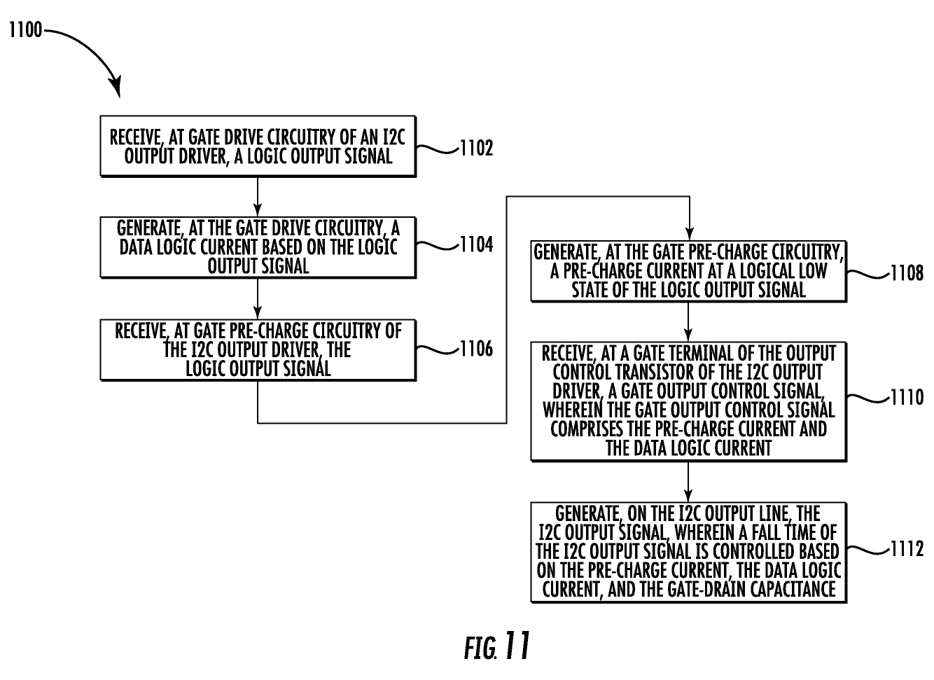

Referring now to FIG. 11, an example flow chart depicting a process 1100 for generating an I2C output signal (e.g., I2C output signal 120, I2C data signal 1020) based on a logic output signal (e.g., logic output signal 110, data output signal 1010) in accordance with the I2C communication protocol, is provided. At block 1102, the logic output signal is received at gate drive circuitry (e.g., gate drive circuitry 108) of an I2C output driver (e.g., I2C output driver 100, 200, 500). As described herein, the logic output signal may comprise a digital signal encoding data and/or a clock intended for transmission on a I2C line (e.g., I2C data line or I2C clock line) in accordance with an I2C communication protocol.

At block 1104, the gate drive circuitry of the I2C output driver generates an output transistor gate control signal (e.g., output transistor gate control signal 114) based on the logic output signal. In some embodiments, the output transistor gate control signal may comprise an inverse of the logic output signal. In addition, in some embodiments, the output transistor gate control signal may be generated comprising a current and/or voltage configured to drive output control circuitry (e.g., output control circuitry 102) in accordance with the I2C communication protocol.

At block 1106, the logic output signal is received at gate pre-charge circuitry (e.g., gate pre-charge circuitry 104) of the I2C output driver.

At block 1108, the gate pre-charge circuitry generates a pre-charge signal (e.g., pre-charge signal 112) at a logical low state of the logic output signal. As described herein, gate pre-charge circuitry may be configured to inject current at the gate of the output control transistor to reduce the turn on time of the output control transistor. In some embodiments, the current of the pre-charge signal may be based on the parasitic capacitances of the output control transistor.

At block 1110, a gate output control signal (e.g., gate output control signal 116) is received at a gate terminal of the output control transistor (e.g., output control transistor 206) of the I2C output driver, wherein the gate output control signal comprises the pre-charge signal and the output transistor gate control signal. The output control transistor comprising a drain terminal electrically connected to an I2C output line, the gate terminal; a source terminal electrically connected to an electrical ground; and the gate-drain capacitance based on a geometry of the drain terminal and the gate terminal. As described herein, in an instance in which the voltage at the gate terminal of the output control transistor exceeds the threshold voltage of the output control transistor, the output control transistor is enabled and the I2C line is electrically connected to ground, pulling the I2C output signal to electrical ground.

At block 1112, the I2C output signal is generated on the I2C output line, wherein a fall time of the I2C output signal is controlled based on the pre-charge signal, the output transistor gate control signal, and the gate-drain capacitance. As described herein, the pre-charge signal and the output transistor gate control signal are combined at the gate terminal of the output control transistor. The output control transistor turn on time is based on the current of the gate output control signal comprising the pre-charge signal and the output transistor gate control signal. The gate-drain capacitance of the output control transistor, along with the other parasitic capacitances of the output control transistor determine the fall time of the I2C output signal.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that utilizes an I2C driver to communicate on an I2C line. For example, an electronic device implementing one or more I2C master devices and/or one more I2C slave devices. Such devices may include microcontrollers, memories, computer monitors, sensors, and many other interconnected devices.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. An inter-integrated circuit (I2C) output driver, configured to receive a logic output signal, the I2C output driver comprising:
an output control transistor, comprising:
a drain terminal electrically connected to an I2C output line;
a gate terminal configured to receive a gate output control signal;
a source terminal electrically connected to an electrical ground; and
a gate-drain capacitance based on a geometry of the drain terminal and the gate terminal;
gate pre-charge circuitry configured to generate a pre-charge signal at a logical low state of the logic output signal; and
gate drive circuitry configured to generate an output transistor gate control signal based on the logic output signal;
wherein the gate output control signal comprises the pre-charge signal and the output transistor gate control signal; and
wherein a fall time of an I2C output signal transmitted on the I2C output line is controlled based on the pre-charge signal, the output transistor gate control signal, and the gate-drain capacitance.

2. The I2C output driver of claim 1, wherein the I2C output signal is one of a serial data line and a serial clock line.

3. The I2C output driver of claim 2, wherein the fall time of the I2C output signal is dependent on the gate-drain capacitance, the pre-charge signal, and the output transistor gate control signal.

4. The I2C output driver of claim 3, wherein the fall time of the I2C output signal is greater than 5.8 nanoseconds and less than 120 nanoseconds.

5. The I2C output driver of claim 1, wherein a gate-drain overlap of the gate terminal of the output control transistor and the drain terminal of the output control transistor is greater than a gate-source overlap of the gate terminal of the output control transistor and the source terminal of the output control transistor.

6. The I2C output driver of claim 1, wherein the output control transistor comprises a high voltage transistor comprising a voltage rating of at least 5.5 Volts.

7. The I2C output driver of claim 1, wherein the gate drive circuitry comprises a first transistor, a current source, and a second transistor electrically connected in series, wherein the first transistor and the second transistor comprise opposite channel types, and wherein the first transistor and the second transistor are configured to receive the logic output signal.

8. The I2C output driver of claim 1, wherein the gate pre-charge circuitry comprises:
a third transistor, a plurality of diode connected transistors, and a fourth transistor electrically connected in series, wherein a pre-charge control signal is generated between the third transistor and the plurality of diode connected transistors.

9. The I2C output driver of claim 8, wherein the gate pre-charge circuitry further comprises:
a fifth transistor configured to generate the pre-charge signal based on the pre-charge control signal in an instance in which the logic output signal transitions from a logic high to a logic low.

10. The I2C output driver of claim 9, further comprising latch-up protection circuitry, wherein the latch-up protection circuitry reduces a voltage of the gate output control signal in an instance in which the gate output control signal approaches a threshold voltage.

11. The I2C output driver of claim 10, wherein the latch-up protection circuitry comprises a sixth transistor electrically connected in series with the fourth transistor between the gate terminal of the output control transistor and the electrical ground, and wherein the sixth transistor and the fourth transistor comprise opposite channel types.

12. An electronic system comprising:
data generator circuitry configured to generate one or more data output signals; and
an I2C output driver comprising:
an output control transistor, comprising:
a drain terminal electrically connected to an I2C data line;
a gate terminal configured to receive a gate output control signal;
a source terminal electrically connected to an electrical ground; and
a gate-drain capacitance based on a geometry of the drain terminal and the gate terminal;
gate pre-charge circuitry configured to generate a pre-charge signal at a logical low state of the logic output signal; and
gate drive circuitry configured to generate an output transistor gate control signal based on the data output signal;
wherein the gate output control signal comprises the pre-charge signal and the output transistor gate control signal; and
wherein a fall time of an I2C data signal transmitted on the I2C data line is controlled based on the pre-charge signal, the output transistor gate control signal, and the gate-drain capacitance.

13. The electronic system of claim 12, wherein the fall time of the I2C data signal is dependent on the gate-drain capacitance, the pre-charge signal, and the output transistor gate control signal.

14. The electronic system of claim 13, wherein the fall time of the I2C data signal is greater than 5.8 nanoseconds and less than 120 nanoseconds.

15. The electronic system of claim 12, wherein a gate-drain overlap of the gate terminal of the output control transistor and the drain terminal of the output control transistor is greater than a gate-source overlap of the gate terminal of the output control transistor and the source terminal of the output control transistor.

16. The electronic system of claim 12, wherein the gate drive circuitry comprises a first transistor, a current source, and a second transistor electrically connected in series, wherein the first transistor and the second transistor comprise opposite channel types, and wherein the first transistor and the second transistor are configured to receive the logic output signal.

17. The electronic system of claim 12, wherein the gate pre-charge circuitry comprises:
a third transistor, a plurality of diode connected transistors, and a fourth transistor electrically connected in series, wherein a pre-charge control signal is generated between the third transistor and the plurality of diode connected transistors; and
a fifth transistor configured to generate the pre-charge signal based on the pre-charge control signal in an instance in which the logic output signal transitions from a logic high to a logic low.

18. The electronic system of claim 17, the I2C output driver further comprising latch-up protection circuitry, wherein the latch-up protection circuitry reduces a voltage of the gate output control signal in an instance in which the gate output control signal approaches a threshold voltage.

19. The electronic system of claim 18, wherein the latch-up protection circuitry comprises a sixth transistor electrically connected in series with the fourth transistor between the gate terminal of the output control transistor and the electrical ground, and wherein the sixth transistor and the fourth transistor comprise opposite channel types.

20. A method for generating an I2C output signal based on a logic output signal, the method comprising:
receiving, at gate drive circuitry of an I2C output driver, the logic output signal;
generating, at the gate drive circuitry, an output transistor gate control signal based on the logic output signal;
receiving, at gate pre-charge circuitry of the I2C output driver, the logic output signal;
generating, at the gate pre-charge circuitry, a pre-charge signal at a logical low state of the logic output signal;
receiving, at a gate terminal of the output control transistor of the I2C output driver, a gate output control signal, wherein the gate output control signal comprises the pre-charge signal and the output transistor gate control signal, the output control transistor comprising:
a drain terminal electrically connected to an I2C output line;
the gate terminal;
a source terminal electrically connected to an electrical ground; and
a gate-drain capacitance based on a geometry of the drain terminal and the gate terminal;
generating, on the I2C output line, the I2C output signal, wherein a fall time of the I2C output signal is controlled based on the pre-charge signal, the output transistor gate control signal, and the gate-drain capacitance.
